(19) United States
(12) Patent Application Publication
(10) Pub. No.: US 2018/0101669 A1
(43) Pub. Date: Apr. 12, 2018

(54) DEVICE TO PERFORM SECURE BIOMETRIC AUTHENTICATION

(71) Applicant: QUALCOMM Incorporated, San Diego, CA (US)

(72) Inventors: Olivier Jean Benoit, San Diego, CA (US); David Tamagno, Livermore, CA (US)

(21) Appl. No.: 15/401,890

(22) Filed: Jan. 9, 2017

Related U.S. Application Data
(60) Provisional application No. 62/406,857, filed on Oct. 11, 2016.

(51) Int. Cl. G06F 21/32; G06F 17/30

(52) U.S. Cl. CPC G06F 21/32; G06F 17/30997

(57) ABSTRACT

Aspect may relate to a device that comprises a sensor and a first secure processor. The sensor may receive an input and generate raw data from the input. The first secure processor may control a first execution environment to perform operations including receiving the raw data from the sensor. Further, the device may include a second processor to control a second execution environment to perform operations including: receiving the raw data; performing data processing to determine normalized data from the raw data and additional data; performing feature extraction to the normalized data to determine features; and sending the features to the first execution environment. The first execution environment may use the features to match the features with stored reference features to authenticate a user.

### CROSS REFERENCE TO RELATED APPLICATIONS

The present application claims priority to U.S. Provisional Patent Application No. 62/406,857 filed Oct. 11, 2016, entitled “DEVICE TO PERFORM SECURE BIOMETRIC AUTHENTICATION,” the content of which is hereby incorporated by reference in its entirety for all purposes.

### FIELD

The present invention relates to a device that performs secure biometric authentication.

### RELEVANT BACKGROUND

Devices that provide user authentication based upon biometric input data often utilize multiple execution environments (EEs). For example, one EE may be a high performance EE to run complex use cases such as high level operating systems. Another EE may be directed to security functions. For authentication purposes, devices may utilize biometric data (e.g., fingerprint scan, facial scan, iris scan, voice recognition) as input data for authentication.

These types of biometric authentication processes involve intensive computational demand in order to provide a high level of security. It has been found that by running a high performance EE exclusively to provide biometric authentication, which operates at a relatively fast speed, the theoretical security level is good but in practice such environment is subject to many vulnerabilities leading to an overall weak security level. On the other hand, running exclusively in a high security EE does not provide the expected speed-based performance level and the user experience level desired, due to the length of time required for the intense computational processing. Therefore, techniques to provide the security level desired for a user based upon the use of biometric data for authentication, as well as suitable performance time for an adequate user experience, are sought after.

### SUMMARY

Aspect may relate to a device that comprises a sensor and a first secure processor. The sensor may acquire or generate raw data from a physical measurement input. The first secure processor may control a first execution environment to perform operations including receiving the raw data from the sensor. Further, the device may include a second processor to control a second execution environment to perform operations including: receiving the raw data; performing data processing to determine normalized data from the raw data and additional data; performing feature extraction to the normalized data to determine features; and sending the features to the first execution environment. The first execution environment may use the features to match the features with stored reference features to authenticate a user.

### BRIEF DESCRIPTION OF THE DRAWINGS

FIG. 1 is a diagram of a system in which embodiments may be practiced.

FIG. 2 is a diagram of one example of the operations of the first and second execution environments in authenticating a user.

FIG. 3A is an example of a fingerprint image used for authentication.

FIG. 3B is a diagram of an example of the operations of the first and second execution environments in authenticating a user based upon a fingerprint image.

FIG. 3C is an example of an iris image used for authentication.

FIG. 3D is a diagram of an example of the operations of the first and second execution environments in authenticating a user based upon an iris image.

FIG. 4 is a diagram of another example of the operations of the first and second execution environments in authenticating a user.

FIG. 5 is a diagram of another example of the operations of the first and second execution environments in authenticating a user.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, or any type of computing device or data processing apparatus.

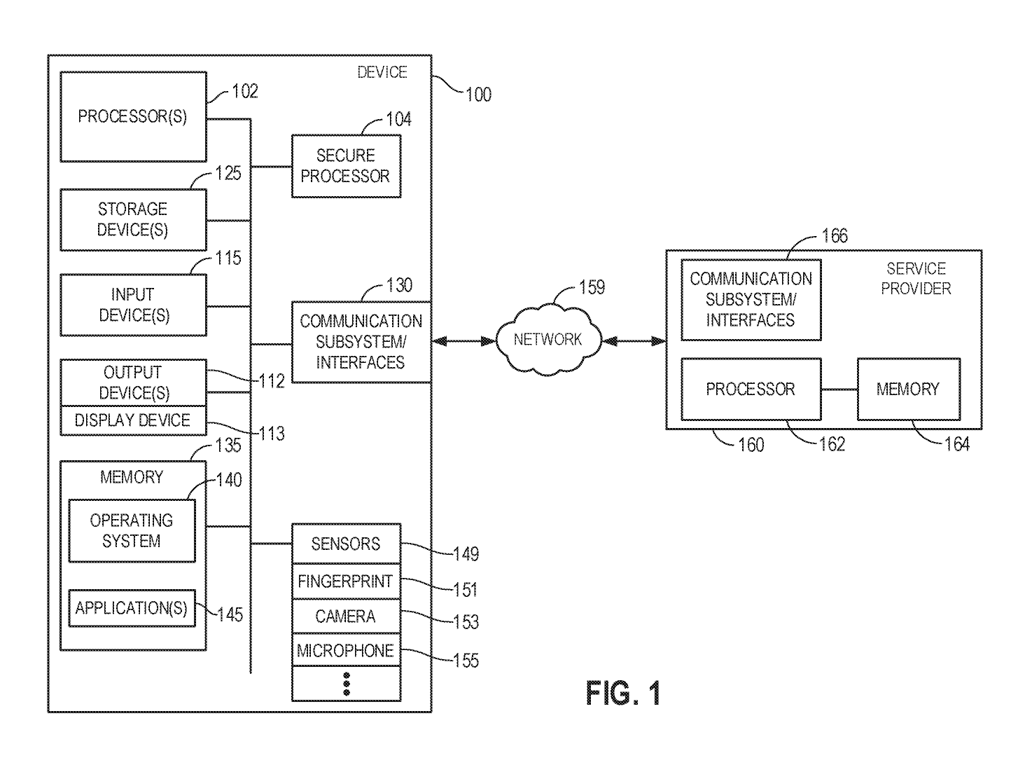

With reference to FIG. 1, an example device 100 may be in communication with one or more other computing devices 160 (e.g., service providers), respectively, via a network 159. For example, remote computing device 160 may be a service provider (e.g., finance, commerce, medical, government, corporate, social networking, etc.) that provides services based on data exchanges with device 100 through the network 159.

As an example, device 100 may comprise hardware elements that can be electrically coupled via a bus (or may otherwise be in communication, as appropriate). The hardware elements may include: one or more processors 102, including without limitation one or more general-purpose processors and/or one or more special-purpose processors (such as digital signal processing chips, graphics acceleration processors, and/or the like); one or more secure processors 104; one or more input devices 115 (e.g., keyboard, keypad, touchscreen, mouse, etc.); and one or more output devices 112—such as a display device (e.g., screen) 113, speaker, etc. Additionally, device 100 may include a wide variety of sensors 149. Sensors may include: a clock, an ambient light sensor (ALS), a biometric sensor (e.g., blood pressure monitor, etc.), an accelerometer, a gyroscope, a magnetometer, an orientation sensor, a weather sensor (e.g., temperature, wind, humidity, barometric pressure, etc.), a Global Positioning Sensor (GPS), an infrared (IR) sensor, a proximity sensor, near field communication (NFC) sensor, or any type of sensor. Further, some of the sensors 149 may include: a fingerprint sensor 151, a camera 153, a microphone 155, or any type of sensor. In particular, as will be described, some of these types of sensor may be used for biometric authentication by a user.

In one embodiment, processor 102 may control applications related to operating systems and other applications. Further, in one embodiment, a secure processor 104 may be utilized to perform operations to be hereafter described related to user authentication based upon biometric data input. In one embodiment, secure processor 104 may be a separate secure processing unit (SPU) with dedicated hardware, software, firmware, memory, etc., to perform the functions to be hereafter described. In one embodiment, processor 102 may operate a second high performance execution environment to perform particular operations, as will be hereafter described, while secure processor 104 may operate a first high security execution environment to perform particular operations, as will be hereafter described. It should be appreciated that in some embodiments, a single processor may perform all of these operations.

Device 100 may further include (and/or be in communication with) one or more non-transitory storage devices or non-transitory memories 125, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Computing device 100 may also include communication subsystems and/or interfaces 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communications subsystems and/or interfaces 130 may permit data to be exchanged with other computing devices 160 (e.g., service providers, etc.) through an appropriate network 159 (wireless and/or wired).

In some embodiments, computing device 100 may further comprise a working memory 135, which can include a RAM or ROM device, as described above. Computing device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (and/or a processor within a device); in an aspect, then, such code and/or instructions can be used to configure and/or adapt a device to perform one or more operations in accordance with the described methods, according to embodiments described herein.

A set of these instructions and/or code may be stored on a non-transitory computer-readable storage medium, such as the storage device(s) 125 described above. In some cases, the storage medium might be incorporated within a computer system, such as device 100. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by device 100 and/or might take the form of source and/or installable code, which, upon compilation and/or installation on device 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other computing devices such as network input/output devices may be employed.

As previously described, device 100 may be any type of device, computer, smartphone, tablet, cellular telephone, watch, wearable device, SoC, Internet of Things (IoT) device, etc. Further, as has been previously described, device 100 may be in communication via interface 130 through network 159 to a service provider 160. It should be appreciated that service provider 160 may be a computing device having at least a processor 162, a memory 164, an interface/communication subsystem 166, as well as other hardware and software components, to implement operations. For example, service provider 160 may be a particular type of service provider (e.g., finance, commerce, medical, government, corporate, social networking, etc.) that provides services based on data exchanges with computing device 100 through the network 159. It should be appreciated that computing device 100 and service provider 160 may be in communication through network 159 in a wireless, wired, or combination of wireless/wired fashion.

In one embodiment, two execution environments (EEs), in which one EE is dedicated to security and another EE is dedicated to high performance, may be utilized. In one embodiment, the high performance EE may be dedicated to data processing and feature extraction at a high performance rate and a security EE may verify the output of the data processing and feature extraction provided by the high performance EE based upon additional data provided by the high performance EE. As will be described, this additional data allows for fast verification against the raw data obtained directly from the sensor 149. Various embodiments will be described hereafter that provide various examples.

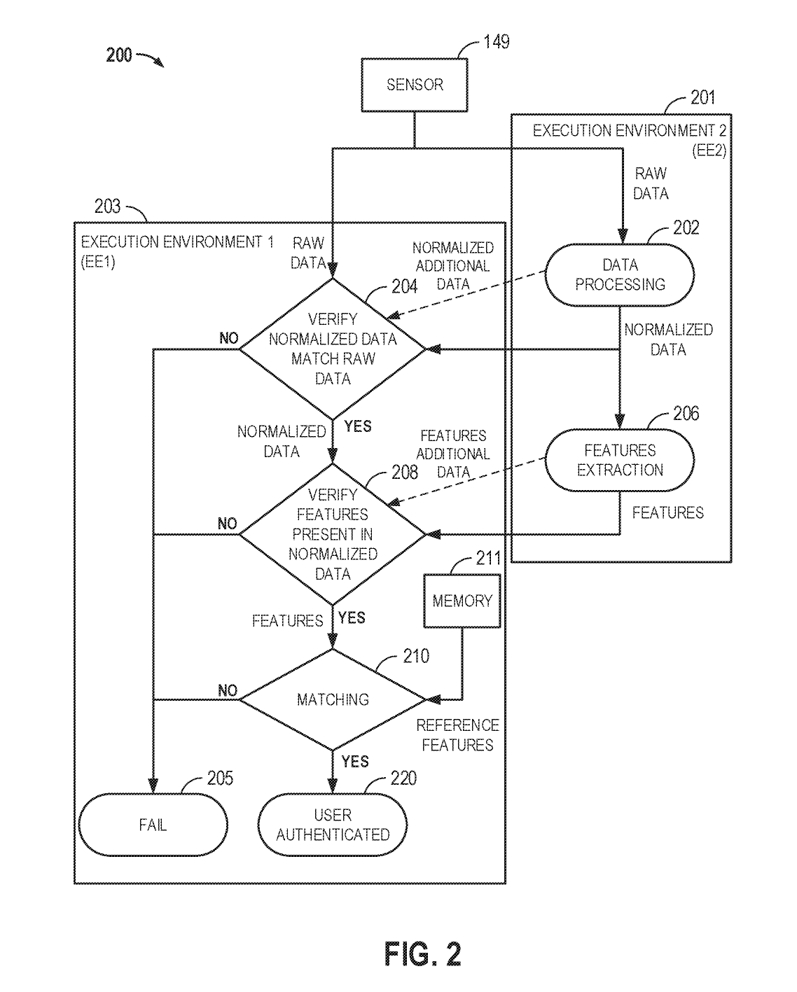

With reference to FIG. 2, an example will be described. As shown in FIG. 2, a sensor 149 may be used to receive an input and to generate raw data from the input which may be sent to a second execution environment (EE2) 201 and a first execution environment (EE1) 203. In one embodiment, first secure processor 104 may be used to control the first EE1 to perform operations including receiving the raw data from the sensor 149, and as will be described, performing matching features 210 based upon the received raw data with stored reference features from memory 211 to authenticate a user. Further, a second processor 102 to control the second EE2 201 may be used to perform operations including: receiving the raw data from sensor 149; performing data processing 202 to determine normalized data from the raw data and normalized additional data; performing feature extraction 206 to the normalized data to determine features; and sending the features to EE1 203. EE1 203 may use the features to match the features with stored reference features from memory 211 to authenticate a user. A user may then be authenticated 220.

It should be appreciated that the sensor data inputted as raw data from sensor 149 may be any type of biometric data utilized for biometric authentication of a user. Examples of these may include fingerprint image data from a fingerprint sensor 151, facial image data from a camera 153, iris image data from a camera 153, voice data from a microphone 155, etc., from a user. It should be appreciated that any type of biometric data input for a user may be utilized. Further, as will be described, utilizing a high performance EE2 201 to perform such items as data processing and feature extraction in combination with a high security EE1 203 provides enhanced security along with high performance to provide an enhanced user experience.

As one particular example 200, shown in FIG. 2, sensor 149 may send raw data to both high performance EE2 201 and high security EE1 203. As has been described, sensor 149 receives input data and generates or acquires raw data from the input. In one embodiment, high performance EE2 201 receives the raw data and performs data processing 202 to determine normalized data and normalized additional data from the raw data. Further, high performance EE2 201 performs feature extraction 206 on the normalized data to determine both features and features additional data for the features that is sent to high security EE1 203. EE1 203 receives the raw data from sensor 149, the normalized data, and the normalized additional data from EE2 201 at decision block 204. At decision block 204, EE1 203 verifies whether the normalized data matches the raw data. If it does not, the process fails (Block 205). However if the normalized data matches the raw data, then EE1 203 moves to decision block 208. At decision block 208, based on the features and the features additional data received from EE2 201, EE1 203 verifies whether the features are present in the normalized data. If not, the process fails at block 205. However, if the features are present, then EE1 moves to matching decision block 210, where it is determined whether the features from the received features match the reference features stored in memory 211. If not, the process fails (Block 205). However, if the reference features match the features based upon the received normalized data, then the user is authenticated (Block 220). It should be appreciated that a wide variety of reference features may be previously stored to memory 211 to possibly authenticate a user, and can be compared against the received data from sensor 149, to determine if there is proper matching, such that a user is authenticated 220.

As has been previously described, these types of reference features for comparison may be related to biometric data for authentication such as: fingerprint image data, facial image data, iris image data, and voice data. For example, if the received features from the fingerprint image data, such as, minutia, match the stored minutia reference features for the stored fingerprint stored in memory, then the user may be authenticated. As another example, if the received features from the facial image data, match the stored facial reference features for the stored facial image stored in memory, then the user may be authenticated. As yet another example, if the received features from the iris image data, match the stored iris reference features for the stored iris image stored in memory, then the user may be authenticated. Similarly, if the received features from the voice data match the stored voice reference features for the voice stored in memory, then the user may be authenticated. It should be appreciated that these are only examples and that any type of features from any type of data may utilized for comparison and authentication.

It should be appreciated that data processing 202 may include searching for the best parameters/coefficients for the various steps of pre-processing (including filter coefficients, recoverable vs. non-recoverable data identifications, etc.). In particular, data processing 202 may provide the best image or data set or signal from the raw data (the normalized data) and the best parameters/coefficients to determine the normalized data (normalized additional data). Thus, data processing 202 may determine normalized data (e.g., best image, best data set, best signal, etc.) and the best determined parameters/coefficients (normalized additional data) to determine the normalized data. This can be done at a much faster rate utilizing the high performance EE2 201. As previously described, the normalized data and normalized additional data may be sent to high security EE1 203 for use.

As one example, normalization may include orientating the image in the same direction as the reference image/feature stored in memory. Utilizing features extraction 206, the features can be extracted (e.g., feature coordinates) in a normalized fashion for direct matching for stored reference features. Features extraction 206 may determine and provide the features (e.g., feature coordinates) to high security EE1 and/or may provide the features additional data with respect to determining the features (e.g., feature coordinates) to the high security EE1.

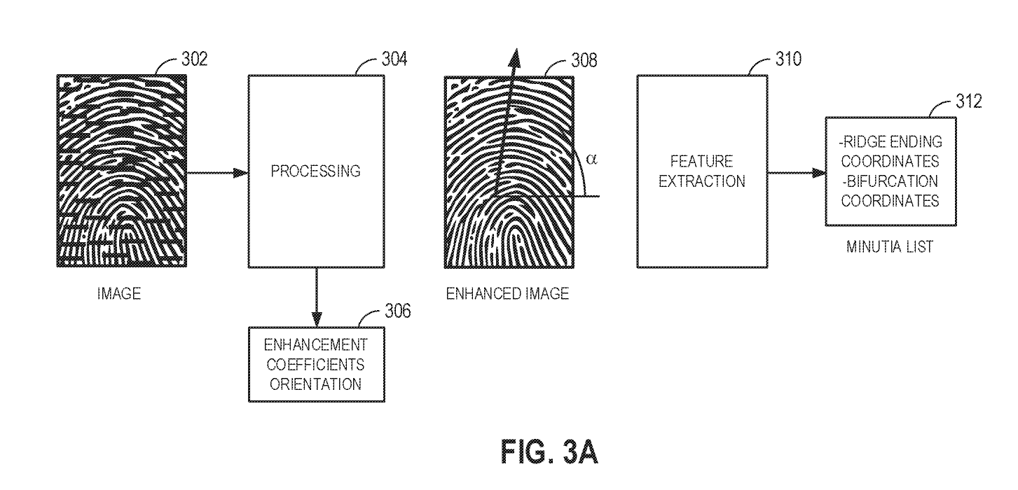

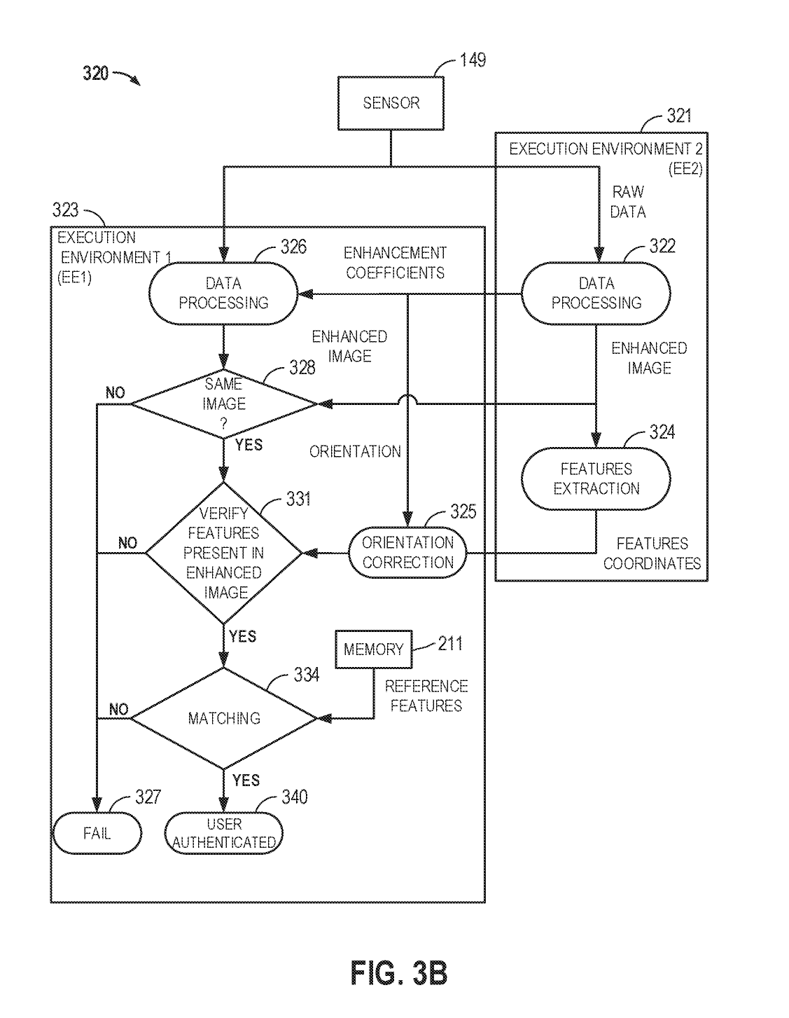

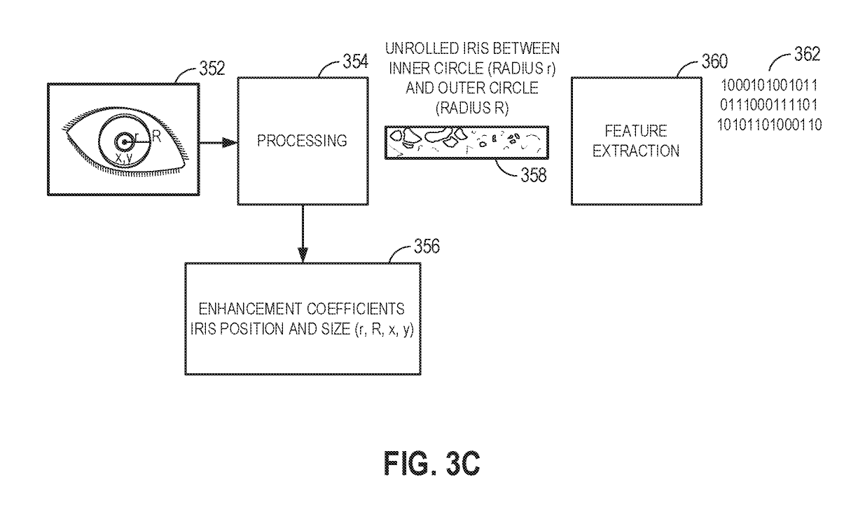

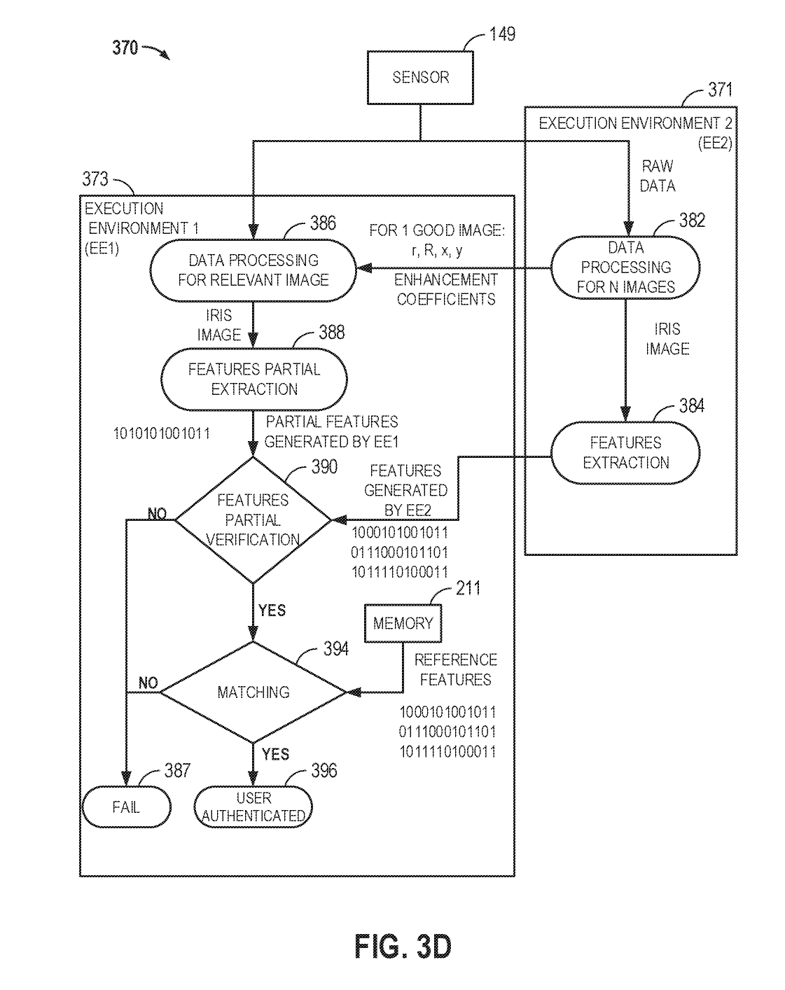

With additional reference to FIG. 3A, an example of a fingerprint image for authentication will be described. A raw fingerprint image 302 may undergo processing 304. Thus, the input is the raw image of the fingerprint and the output normalized data is the enhanced image 308, as well as, enhancement coefficients/parameters with respect to orientation 306 (normalized additional data) to achieve the enhanced image. Thus, EE2 may send both the normalized data/enhanced image 308 to EE1 and the normalized additional data which includes enhancement coefficients/parameters such as an angle and orientation to EE1. Feature extraction 310 may be applied by either EE1 or EE2 to determine the feature output that includes a minutia list which includes coordinates of ridge endings and bifurcations for comparison with the reference image. An example will be provided below.

With additional reference to FIG. 3B, an example 320 of the high performance EE2 321 and the high security EE1 323 implementation for a fingerprint image will be described. In FIG. 3B, sensor 149 (e.g., fingerprint sensor 151) may send raw data to both high performance EE2 321 and high security EE1 323. In one embodiment, as has been described, high performance EE2 321 receives the raw data and performs data processing 322 to determine an enhanced fingerprint image and normalized additional data (enhancement coefficients and orientation data) from the raw data. Further, high performance EE2 321 performs feature extraction 324 on the enhanced fingerprint image to determine feature coordinates for the features that are sent to high security EE1 323. EE1 323 also receives the raw data from sensor 149 (e.g., fingerprint sensor 151) and also performs data processing 326 based upon the enhancement coefficients from EE2 321 to create the enhanced fingerprint image. At block 328, EE1 323 determines whether its enhanced fingerprint image is the same fingerprint image received from EE2 321, and, if not, the process fails 327, and if so, the process moves to verification decision block 331.

At verification decision block 331, based on the features coordinates and orientation correction 325 received from EE2 321, EE1 323 verifies whether the features are present in the enhanced fingerprint image (e.g., minutia components). If not, the process fails at block 327. However, if the features are present, then EE1 323 moves to matching decision block 334, where it is determined whether the features from the received features for the fingerprint image match the reference features for the fingerprint image stored in memory 211. If not, the process fails (Block 327). However, if the reference features for the stored fingerprint image (e.g., feature coordinates related to a minutia list) match the features for the received enhanced fingerprint image (e.g., feature coordinates related to a minutia list), then the user is authenticated (Block 340).

With additional reference to FIG. 3C, an example of an iris image for authentication will be described. An eye image 352 may undergo processing 354. Thus, the input is the raw image of the eye and the output is an unrolled iris 358 between inner circle (radius r) and outer circle (radius R). Further, processing 354 determines and outputs enhancement coefficients 356 (normalized additional data) related to iris position (x,y) and size (r, R) that were used to achieve the enhanced image. The unrolled iris image 358 may undergo feature extraction 360 to generate a binary pattern 362 to be utilized as part of the matching procedure. In this way, normalized additional data (enhancement coefficients 356) is calculated for at least one good image (e.g., by EE2). The normalized additional data is related to the center of the eye (x,y) and radius of the inner and outer circle (r and R). Based upon this EE1 can extract features from the raw image, as will be described. Also, as will be described, EE1 may compare features (binary patterns for the iris image) generated by EE2 against the reference features. An example will be provided below.

With additional reference to FIG. 3D, an example 370 of the high performance EE2 371 and the high security EE1 373 implementation for an iris image will be described. In FIG. 3D, sensor 149 (e.g., camera 155) may send raw data to both high performance EE2 371 and high security EE1 373. In one embodiment, as has been described, high performance EE2 371 receives the raw data and performs data processing 382 on N images to determine an iris image and normalized additional data (enhancement coefficients related to iris position and size (r, R, x, y) from the raw data. EE1 at block 386 performs data processing for the relevant iris image based on the normalized additional data to create an enhanced iris image from the raw data. Further, at block 388, high security EE1 373 may perform a partial features extraction on the enhanced iris image. The partial feature extraction may be used as part of a challenge against a feature generated by EE2 371. In particular, at decision block 390, it is determined whether the partial feature generated by EE1 373 matches a feature generated by EE2 371. If not, the process fails (block 387). If partial verification is met, the process moves on to matching decision block 394. It should be noted that EE1 373 may receive a challenge feature generated by EE2 371 and verifies that it at least partially matches the one it extracted on its own from the image such that it verify there is not an attack taking place is the less secure environment EE2 371. This is a fast security check. Further, after passing the security check, EE1 373 moves to matching decision block 394, where it is determined whether the features from the received features for the received iris image (e.g., binary patterns) generated by the feature extraction 384 of EE2 371 match the reference features (e.g., binary patterns) for the iris image stored in memory 211. If not, the process fails (Block 387). However, if the reference features for the stored iris image (e.g., binary patterns) match the features for the received iris image (e.g., binary patterns), then the user is authenticated (Block 396).

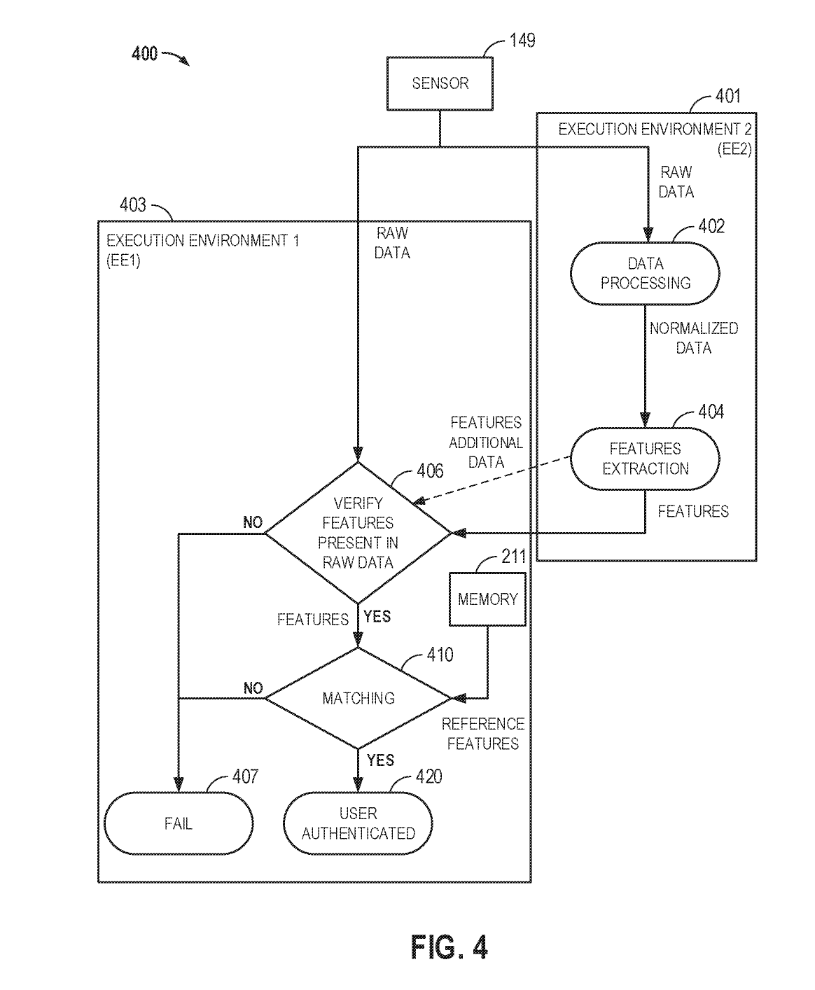

As another general example 400 shown in FIG. 4, sensor 149 may send raw data to both high performance EE2 401 and high security EE1 403. As has been described, sensor 149 receives input data and generates raw data from the input. In one embodiment, high performance EE2 401 receives the raw data and performs data processing 402 to determine normalized data from the raw data. Further, high performance EE2 401 performs feature extraction 404 on the normalized data to determine both features and features additional data for the features that are sent to high security EE1 403. EE1 403 receives the raw data from sensor 149 and the features and the features additional data from EE2 401. Based upon the received features and the features additional data from EE2 401, at decision block 406, EE1 403 verifies whether the features are present in the raw data. If not, the process fails at block 407. However, if the features are present in the raw data, then EE1 403 moves to matching decision block 410, where it is determined whether the features from the received features match the reference features stored in memory 211. If not, the process fails (Block 407). However, if the reference features match the received features, then the user is authenticated (Block 420). It should be appreciated that a wide variety of reference features may be previously stored to memory 211 to possibly authenticate a user, and, can be compared against the received data from sensor 149 to determine if there is proper matching, such that a user is authenticated 420.

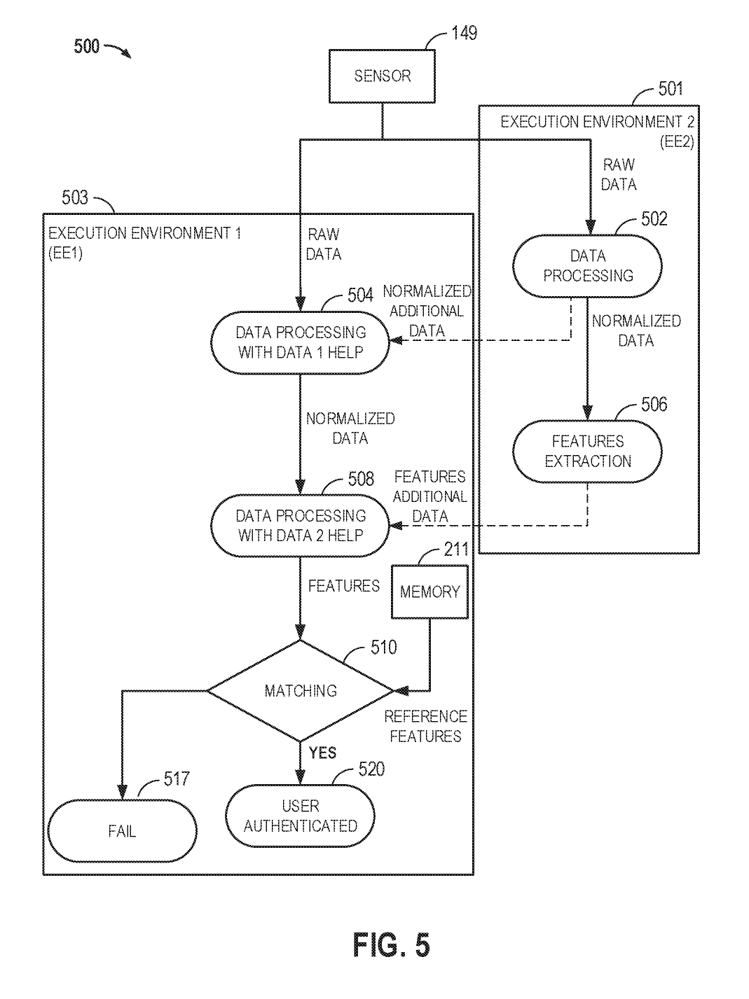

As another general example 500 shown in FIG. 5, sensor 149 may send raw data to both high performance EE2 501 and high security EE1 503. As has been described, sensor 149 receives input data and generates raw data from the input. In one embodiment, high performance EE2 501 receives the raw data and performs data processing 502 to determine normalized data and normalized additional data from the raw data. Further, high performance EE2 501 performs feature extraction 506 on the normalized data to determine features additional data for the features that are sent to high security EE1 503. EE1 503 receives the raw data from sensor 149 and the normalized additional data from EE2 501 at data processing 504, where EE1 generates normalized data based upon received normalized additional data from EE2 501 (e.g., data 1 help). At block 508, EE1 503 performs data processing for feature extraction on the normalized data to extract features based upon the features additional data received from EE2 501 (e.g., data 2 help). At matching decision block 510, EE1 503 determines whether the extracted features match the reference features stored in memory 211. If not, the process fails (Block 517). However, if the reference features match the features based upon the received normalized data, then the user is authenticated (Block 520). It should be appreciated that a wide variety of reference features may be previously stored to memory 211 to possibly authenticate a user, and, can be compared against the received data from sensor 149 to determine if there is proper matching, such that a user is authenticated 520.

As has been previously described, data processing in the various embodiments of EE1 and EE2 may be utilized to search for the best parameters/coefficients for the various steps of image pre-processing (including filter coefficients, recoverable vs. non-recoverable data identifications, etc.). In particular, data processing may provide the best image from the raw data (the normalized data) and the best parameters/coefficients to determine the normalized data (normalized additional data). Thus, data processing may determine normalized data (e.g., best image) and the best determined parameters/coefficients (normalized additional data) to determine the normalized data (e.g., best image). As has been described, this can be done at a much faster rate utilizing a high performance EE2 and the normalized data and/or normalized additional data may be sent to a high security EE1 for various purposes, as described in the previous embodiments. Examples may include orientating images in the same direction as the reference image/feature stored in memory. Further, as has been described, features extraction in the various EE1 and EE2 implementations provide that features can be extracted (e.g., feature coordinates, binary patterns, etc.) in a normalized fashion for direct matching for stored reference features. Features extraction may determine and provide the features (e.g., feature coordinates, binary patterns, etc.) to high security EE1 and/or may provide the features additional data with respect to determining the features (e.g., feature coordinates binary patterns, etc.) to the high security EE1.

Further, although various types of features for biometric data authentication have been described, such as: fingerprint image data, facial image data, iris image data, voice data, etc. It should be appreciated that these are only examples and that any type of features from any type of data may utilized for comparison and authentication for a user. These may include any type of image data, sound data, voice data, visual data, biometric input data, or any type of data that can be used for authentication.

As described in the previous embodiments, by having a high security EE1 perform normalized data feature verification in parallel with feature extraction being performed by a high performance EE2, enhanced security is provided along with high performance to provide an enhanced user experience. Also, because the verification of the processed information (normalized data and features) outside of high security EE1 are not replayed data and match totally or partially the raw data from the sensor provides a significant benefit. Further, as previously described, a wide variety of sensors and sensor data for any type of biometric data utilized for biometric authentication may be utilized. Examples of these may include fingerprint image data from a fingerprint sensor, facial image scan data from a camera, iris scan image data from a camera, voice scan data from a microphone, etc. However, it should be appreciated that any type of biometric data input may be utilized. Further, as has been described, utilizing a high performance EE2 to perform such items as data processing and/or feature extraction in combination with a high security EE1 provides enhanced security along with high performance to provide an enhanced suitable user experience.

It should be appreciated that aspects of the previously described processes may be implemented in conjunction with the execution of instructions by a processor (e.g., processor 102 and/or processor 104) of devices (e.g., device 100), as previously described. Particularly, circuitry of the devices, including but not limited to processors, may operate under the control of a program, routine, or the execution of instructions to execute methods or processes in accordance with embodiments described (e.g., the processes and functions of FIGS. 2-5). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a SoC, a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a secure processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A device comprising:
a sensor to receive an input and to generate raw data from the input;
a first secure processor to control a first execution environment to perform operations including receiving the raw data from the sensor; and
a second processor to control a second execution environment to perform operations including:
receiving the raw data;
performing data processing to determine normalized data from the raw data and additional data;
performing feature extraction to the normalized data to determine features; and
sending the features to the first execution environment, wherein the first execution environment uses the features to match the features with stored reference features to authenticate a user.

2. The device of claim 1, wherein the second execution environment determines the additional data for the normalized data and sends the additional data for the normalized data to the first execution environment.

3. The device of claim 2, wherein the first execution environment uses the additional data for the normalized data to verify that normalized data received from the second execution environment matches received raw data.

4. The device of claim 2, wherein the first execution environment uses the additional data for the normalized data to perform data processing to determine the normalized data from the raw data.

5. The device of claim 2, wherein the second execution environment determines additional data for the features and sends the data for the features to the first execution environment.

6. The device of claim 1, wherein the sensor is a camera, and the raw data is related to an iris image of the user.

7. The device of claim 1, wherein the sensor is a fingerprint sensor, and the raw data is related to a fingerprint image of the user.

8. A method comprising:
receiving an input;
generating raw data from the input;
controlling a first execution environment to perform operations including receiving the raw data; and
controlling a second execution environment to perform operations including:
receiving the raw data;
performing data processing to determine normalized data from the raw data and additional data;
performing feature extraction to the normalized data to determine features; and
sending the features to the first execution environment, wherein the first execution environment uses the features to match the features with stored reference features to authenticate a user.

9. The method of claim 8, wherein the second execution environment determines the additional data for the normalized data and sends the additional data for the normalized data to the first execution environment.

10. The method of claim 9, wherein the first execution environment uses the additional data for the normalized data to verify that normalized data received from the second execution environment matches received raw data.

11. The method of claim 9, wherein the first execution environment uses the additional data for the normalized data to perform data processing to determine the normalized data from the raw data.

12. The method of claim 9, wherein the second execution environment determines additional data for the features and sends the additional data for the features to the first execution environment.

13. The method of claim 8, wherein the raw data is received and generated by a camera, and the raw data is related to an iris image of the user.

14. The method of claim 8, wherein the raw data is received and generated by a fingerprint sensor, and the raw data is related to a fingerprint image of the user.

15. A non-transitory computer-readable medium including code that, when executed by a processor of a device, causes the processor to:
receive an input;
generate raw data from the input;
control a first execution environment to perform operations including receiving the raw data; and
control a second execution environment to perform operations including:
receiving the raw data;
performing data processing to determine normalized data from the raw data and additional data;
performing feature extraction to the normalized data to determine features; and
sending the features to the first execution environment, wherein the first execution environment uses the features to match the features with stored reference features to authenticate a user.

16. The computer-readable medium of claim 15, wherein the second execution environment determines the additional data for the normalized data and sends the additional data for the normalized data to the first execution environment.

17. The computer-readable medium of claim 16, wherein the first execution environment uses the additional data for the normalized data to verify that normalized data received from the second execution environment matches received raw data.

18. The computer-readable medium of claim 16, wherein the first execution environment uses the additional data for the normalized data to perform data processing to determine the normalized data from the raw data.

19. The computer-readable medium of claim 16, wherein the second execution environment determines additional data for the features and sends the additional data for the features to the first execution environment.

20. The computer-readable medium of claim 15, wherein the raw data is received and generated by a camera, and the raw data is related to an iris image of the user.

21. The computer-readable medium of claim 15, wherein the raw data is received and generated by a fingerprint sensor, and the raw data is related to a fingerprint image of the user.

22. A device comprising:
means for receiving an input;
means for generating raw data from the input;
means for controlling a first execution environment to perform operations including receiving the raw data; and
means for controlling a second execution environment to perform operations including:
means for receiving the raw data;
means for performing data processing to determine normalized data from the raw data and additional data;
means for performing feature extraction to the normalized data to determine features; and
means for sending the features to the first execution environment, wherein the first execution environment uses the features to match the features with stored reference features to authenticate a user.

23. The device of claim 22, wherein the second execution environment determines the additional data for the normalized data and sends the additional data for the normalized data to the first execution environment.

24. The device of claim 23, wherein the first execution environment uses the additional data for the normalized data to verify that normalized data received from the second execution environment matches received raw data.

25. The device of claim 23, wherein the first execution environment uses the additional data for the normalized data to perform data processing to determine the normalized data from the raw data.

26. The device of claim 23, wherein the second execution environment determines additional data for the features and sends the additional data for the features to the first execution environment.

27. The device of claim 21, wherein the raw data is received and generated by a camera, and the raw data is related to an iris image of the user.

28. The device of claim 21, wherein the raw data is received and generated by a fingerprint sensor, and the raw data is related to a fingerprint image of the user.
